(19) United States
(12) Patent Application Publication
(10) Pub. No.: US 2008/0002417 A1
(43) Pub. Date: Jan. 3, 2008

(54) Bicycle frame combined with illuminating lamp

(75) Inventor: Nai-Chien Mohr, Taipei (TW)

Correspondence Address: BACON & THOMAS, PLLC, 625 SLATERS LANE, FOURTH FLOOR, ALEXANDRIA, VA, 22314, US

(73) Assignee: DEM Inc., Taipei City (TW)

(21) Appl. No.: 11/500,290

(22) Filed: Aug. 8, 2006

(30) Foreign Application Priority Data
Jun. 28, 2006 (TW) 095211319

(51) Int. Cl. B62J 6/00

(52) U.S. Cl. 362/475; 362/473

(57) ABSTRACT

The present invention is directed to a bicycle frame combined with an illuminating lamp. The bicycle frame includes a front pipe for assembling with a handlebar and a front fork. An illuminating lamp is directly built in the front pipe for providing a light source to illuminate the front of the bicycle frame. With this arrangement, unlike the conventional illuminating lamp hung on the outside of the bicycle, the loosening of the illuminating lamp due to the vibration of the bicycle and the deviation of the illuminating angle will not happen.

### BACKGROUND OF THE INVENTION

1. Field of the Invention

The present invention relates to an illuminating lamp for a bicycle, and in particular to an illuminating lamp built in a bicycle frame. With this arrangement, when someone rides the bicycle in a dark environment, the light emitted by the illuminating lamp can be used to illuminate the front road, thereby to assure the safety in riding.

2. Description of Prior Art

In order to assure the safety in riding a bicycle at night or in a dark environment, the illuminating lamp mounted on the handlebar or bicycle frame can be used as the light source for illuminating the front road.

Conventionally, most illuminating lamps used in the bicycle are hung on the outside of the bicycle. That is to say, the illuminating lamp is additionally connected to the handlebar or a proper position of the bicycle frame via a fastener or clip. Since the illuminating lamp hung on the outside of the bicycle must be tightly locked in position, otherwise, it is easy to swing or deflect when the connection between the illuminating lamp and the handlebar or frame is loosened. As a result, the illuminating direction and angle cannot be kept to a predetermined position, causing a serious danger of riding.

Further, since the illuminating lamp hung on the outside of the bicycle is an additional accessory, only if the illuminating lamp is particularly selected to match the style of the bicycle, a common illuminating lamp attached to the bicycle will generate an inharmonious visual effect.

In view of the above problems, the manufactures of the illuminating lamps hung on the bicycle have proposed various kinds of modified fasteners or clips to enhance the fastening effect on the bicycle, by which the illuminating lamp can be more tightly fixed on the bicycle without loosening easily.

However, the illuminating lamp hung on the bicycle via the fastener or clip is still inevitably loosened due to the vibration of the bicycle frame.

### SUMMARY OF THE INVENTION

The present invention provides an illuminating lamp applicable to a bicycle. The illuminating lamp is built in the bicycle frame to provide a light source for illuminating the front of the frame, so that the rider can clearly know the road condition in the front by means of the illuminating lamp, thereby to assure the safety in driving.

The illuminating lamp is embedded in the front pipe portion of the bicycle frame. The front pipe is the portion in which the pipe body located at the front end of the bicycle frame and assembled between the handlebar and the front fork.

The illuminating lamp comprises a lamp case. Within the lamp case, a circuit board and at least one light-emitting element arranged on the circuit board are provided. The lamp case can be exactly inserted into an insertion groove provided in the front of the front pipe. Further, a light-pervious lamp mask is also provided, so that the light emitted from the interior can be used to illuminate the front of the bicycle frame through the lamp mask.

In practice, the illuminating lamp of the present invention can be provided in the interior of the lamp case with power-supplying elements for electrically connecting to the light-emitting element, thereby to supply the necessary power to the light-emitting element. The power-supplying elements include various kinds of common batteries but are not limited thereto. Further, power can be alternatively supplied from the outside. For example, the power-supplying elements disposed to the outside of the lamp case can provide the necessary power for the light-emitting element.

In comparison with the illuminating lamp hung on the outside of the bicycle via the fastener or clip, the present invention proposes an illuminating lamp designed to be built in the front pipe of the bicycle frame. In addition to keep the illuminating direction and angle of the light source constant, the illuminating lamp built in the front pipe of the bicycle frame can also be integrated to become a part of the bicycle frame. Therefore, the addition of the illuminating lamp on the bicycle frame will not cause any inharmonious visual effect.

The bicycle mentioned herein is a broad expression and not limited to the style of the bicycle shown in the figure. Various bicycles, such as sports bicycle, all-terrain bicycle or travel bicycle can be used.

The detailed description and the technical contents relating to the present invention will be made with reference to the accompanying drawings.

### BRIEF DESCRIPTION OF THE DRAWINGS

FIG. 1 is a perspective view of a bicycle in which the bicycle frame is combined with the illuminating lamp of the present invention;

FIG. 2 is a side cross-sectional view showing the bicycle frame combined with the illuminating lamp;

FIG. 3 is an exploded perspective view showing the bicycle frame combined with the illuminating lamp; and

FIG. 4 is an enlarged cross-sectional view showing the bicycle frame combined with the illuminating lamp.

### DETAILED DESCRIPTION OF THE INVENTION

The following embodiments describe the characteristics and advantages of the present invention in detail, so that those skilled in this art can implement the present invention by utilizing the technical content thereof.

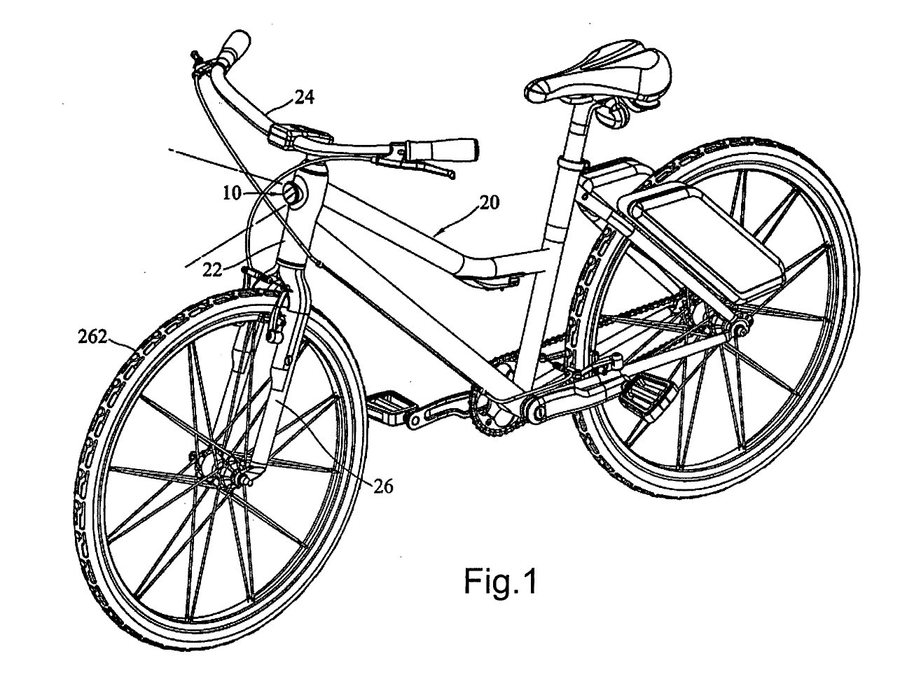

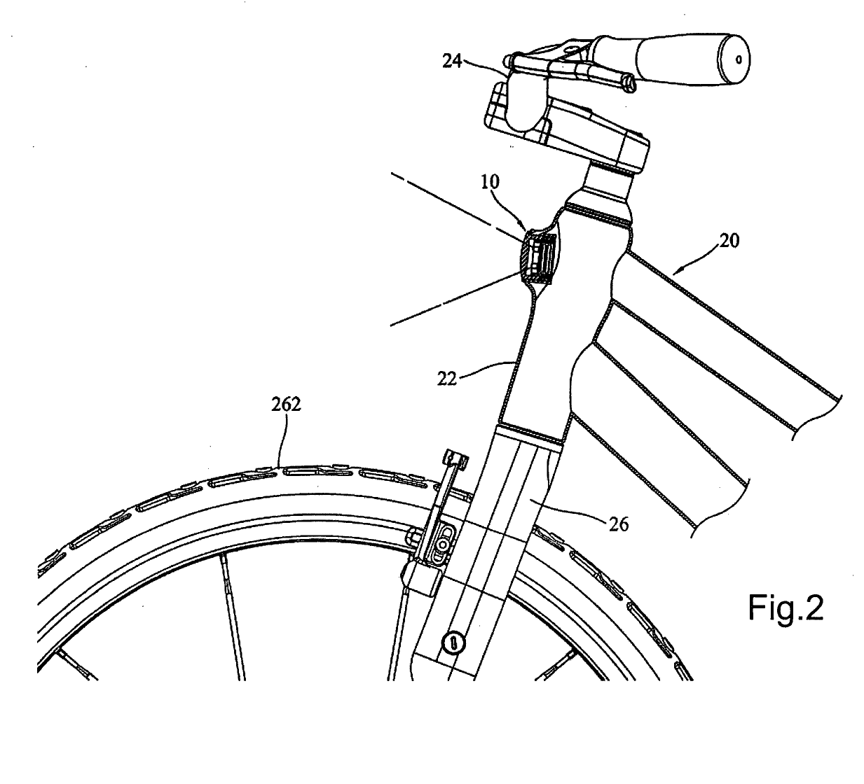

The present invention is directed to an illuminating lamp for a bicycle, thereby to provide a light source for illuminating the front of the bicycle. With reference to FIG. 1 and FIG. 2, the illuminating lamp 10 is combined on the front pipe 22 of the bicycle frame 20. The front pipe 22 is the portion of the bicycle frame 20 for being assembled between the handlebar 24 and the front fork 26, so that the handlebar 24 and the front fork 26 can be supported via the front pipe 22 and connected with the bicycle frame 20. With this arrangement, the handlebar 24 can control the running direction of the front wheel 262 pivotally connected to the front fork 26.

Unlike the conventional illuminating lamp hung on the outside of the bicycle, the illuminating lamp 10 of the present invention is built in the front pipe 22. The illuminating lamp 10 is fixedly connected to the bicycle frame without any fastener and the clip. Therefore, the loosening of the fastener or clip will not happen.

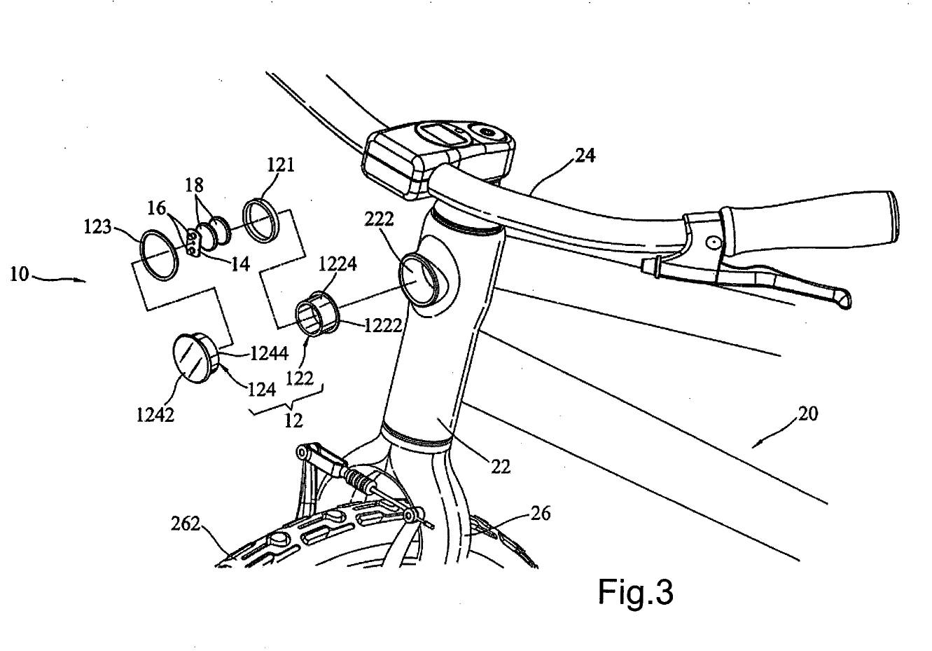

With reference to FIG. 3, it shows a portion of the bicycle frame 20 and the constituting components of the illuminating lamp 10 in an exploded manner. As shown in the figure, the front pipe 20 of the bicycle frame 20 has an insertion groove 222 for mounting the illuminating lamp 10 therein. The insertion groove 222 is a groove or hole provided in the radial direction of the front pipe 22. Further, an opening facing toward the front of the bicycle frame 20 is provided. Further, the shape and the depth of the insertion groove 222 are adapted to exactly receive the illuminating lamp 10, so that the illuminating lamp 10 can be inserted with the front pipe 22 and fixed thereto.

The illuminating lamp 10 comprises a lamp case 12. The interior of the lamp case 12 has a chamber for accommodating a circuit board 14, light-emitting elements 16 and power-supplying elements 18. The lamp case 12 comprises a lamp seat 122 and a light-pervious lamp mask 124 assembled with each other. The lamp seat 122 has a bottom plate 1222 and a first sleeve 1224 extending from the bottom plate 1222 toward one side. The lamp mask 124 has a light-pervious piece 1242 and a second sleeve 1244 extending from the light-pervious piece 1242 toward one side. The shape and size of the first sleeve 1224 and the second sleeve 1244 can be tightly connected, so that the lamp case 12 constituted of the lamp seat 122 and the lamp mask 124 can has a good sealing property.

In order to further improve the internal sealing property of the connected lamp case 12, a first gasket 121 is further provided at the connecting portion of the lamp seat 122 and the lamp mask 124. With this arrangement, the moisture or rain can be prevented from penetrating into the lamp case via the seam to accumulate therein. Further, the electronic elements within the lamp case can be protected from getting wet, and thus the possibility of shortage or leakage of electricity can be reduced.

In order to tightly connect the lamp case 12 into the insertion groove 222 provided within the front pipe 22, the external shape of the lamp case 12 also has the corresponding shape suitable for being inserted into the insertion groove 222. In other words, the shape of the insertion groove 222 and the external shape of the lamp case 12 matches with each other.

On the other hand, in order to prevent the moisture or rain from penetrating into the front pipe 22 via the seam after the connection of the lamp case 12 and the front pipe 22 is completed, a second gasket 123 can be provided in the connecting portion of the lamp case 12 and the front pipe 22. With the second gasket 123, the sealing and water-proof effect can be generated.

In order to generate the light source, the lamp case 12 is provided with a circuit board 14 therein. At least one light-emitting element 16 is mounted on the circuit board 14. Further, within the lamp case 12, at least one power-supplying element 18 is provided for electrically connected to the light-emitting elements 16.

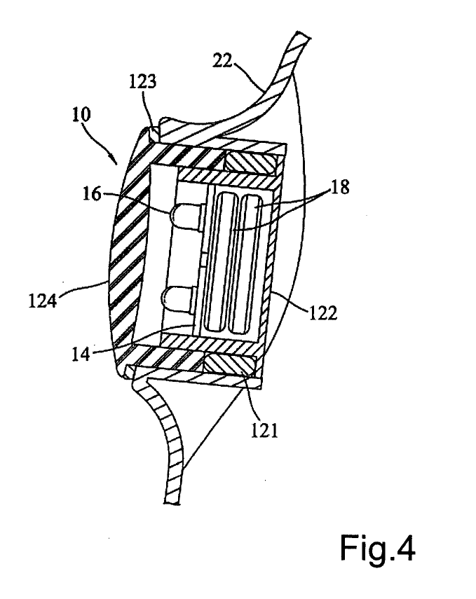

FIG. 4 is a partially enlarged cross-sectional view showing that the illuminating lamp 10 is mounted on the front pipe 22 of the bicycle frame 20. As shown in the figure, the circuit board 14 is fixedly combined into the lamp seat 122 by means of engagement or screws. The light-emitting elements 16 are arranged on the circuit board 14 toward the side of the light-pervious lamp mask 124. Further, the power-supplying elements 18 disposed at the other side of the circuit board 14 are used to provide the necessary power for the light-emitting elements to generate the light source. Therefore, when the illuminating lamp 10 is applied on the bicycle frame 20, the illuminating lamp 10 built in the front pipe 22 can be used to acts as a light source for illuminating the front of the bicycle frame 20.

Of course, the above-mentioned circuit board 14 and light-emitting elements 16 are only one of the preferred embodiments of the present invention. In practice, it is not limited to the above aspect. The light-emitting elements 16 can be light-emitting diodes, in addition, any suitable light-emitting material that can illuminate after being supplied electricity can be used to replace the above light-emitting element, such as a halogens lamp or bulb.

As for the power-supplying element 18, various kinds of batteries may be used. The battery includes the thin battery shown in the drawing and dry battery, but is not limited thereto. Further, the power-supplying elements 18 are not only provided in the lamp case, but also can be integrated with the circuit board 14 and the light-emitting elements 16 in the lamp case 12, thereby to provide the necessary power for the light-emitting elements 16. In practice, the power-supply elements 18 can be designed to dispose to the outside of the lamp case to be electrically connected to the light-emitting element 16 via the leads.

According to the above, the present invention lies in that the illuminating lamp 10 is built in the front pipe 22 of the bicycle frame 22. The light source within the lamp case 12 can illuminate the front of the bicycle frame 20 via the light-pervious lamp mask 124.

In comparison with the conventional illuminating lamp hung on the outside of the bicycle, in the built-in illuminating lamp 10 of the present invention, the loosening of the fastener or clip will not occur as that happened in prior art. Further, since the built-in illuminating lamp 10 is incorporated into the bicycle frame 20, unlike the conventional illuminating lamp additionally hung on the outside of the bicycle, the external appearance of the bicycle frame 20 will not cause any inharmonious visual effect.

Although the present invention has been described with reference to the foregoing preferred embodiment, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A bicycle frame combined with an illuminating lamp, the bicycle frame having a front pipe for assembling with a handlebar and a front fork, the front pipe combined with an illuminating lamp thereon, the illuminating lamp mounted in an insertion groove provided on the front pipe for providing a light source to illuminate the front of the bicycle frame.

2. The bicycle frame combined with an illuminating lamp according to claim 1, wherein the illuminating lamp comprises:
a lamp case combined in the insertion groove;
a circuit board disposed in the lamp case;
at least one light-emitting element disposed on the circuit board; and
a power-supplying element electrically connected to the light-emitting element.

3. The bicycle frame combined with an illuminating lamp according to claim 2, wherein the light-emitting element is selected from any one of the light-emitting diode, halogens lamp and bulb.

4. The bicycle frame combined with an illuminating lamp according to claim 2, wherein the power-supplying element is provided in the lamp case.

5. The bicycle frame combined with an illuminating lamp according to claim 4, wherein the power-supplying element is a battery.

6. The bicycle frame combined with an illuminating lamp according to claim 2, wherein the power-supplying element is provided to the outside of the lamp case.

7. The bicycle frame combined with an illuminating lamp according to claim 1, wherein the lamp case has a corresponding external shape suitable to be inserted into the insertion groove.

8. The bicycle frame combined with an illuminating lamp according to claim 1, wherein the lamp case comprises a lamp seat and a light-pervious lamp mask combined with each other.

9. The bicycle frame combined with an illuminating lamp according to claim 8, wherein the connecting portion of the lamp seat and the light-pervious lamp mask is provided with a first gasket.

10. The bicycle frame combined with an illuminating lamp according to claim 1, wherein the connecting portion of the illuminating lamp and the front pipe is provided with a second gasket.
